(19) United States
(12) Patent Application Publication
(10) Pub. No.: US 2026/0097901 A1
(43) Pub. Date: Apr. 9, 2026

(54) CONVEYING SYSTEM

(71) Applicant: Ocado Innovation Limited, Hatfield (GB)

(72) Inventor: Lawrence SKEEN-SMITH, Hatfield (GB)

(21) Appl. No.: 19/405,107

(22) Filed: Dec. 1, 2025

Related U.S. Application Data
(63) Continuation of application No. PCT/EP2024/065236, filed on Jun. 3, 2024.

(30) Foreign Application Priority Data
Jun. 2, 2023 (GB) 2308286.0

(51) Int. Cl. B65G 13/075; B65G 21/20; B65G 47/26; B65G 47/29; B65G 47/54; B65G 47/88

(52) U.S. Cl. CPC B65G 13/075; B65G 21/2045; B65G 47/266; B65G 47/295; B65G 47/54; B65G 47/8815

(57) ABSTRACT

A conveying system, the conveying system including a conveyor arranged for conveying a storage container; a body shaped to comprise a ramp to enable the storage container to move along a first path and a substantially vertical face forming a stopping surface for stopping the storage container from moving along a second path; wherein the body is moveable between a retracted position to permit movement of the storage container along the first path of the conveyor and a raised position to prevent movement of the storage container along the second path of the conveyor; the second path being directionally opposite to the first path; wherein the body is resiliently biased in the raised position and the bias is overcome by the storage container riding over the ramp.

### FIELD OF INVENTION

The present invention relates to the field of a storage and retrieval system for handling storage containers or bins stacked in a grid framework structure, more particularly to a conveying system comprising a stop for controlling movement of a handling storage container around the conveying system.

### BACKGROUND

Storage systems comprising a three-dimensional storage grid structure, within which storage containers/bins are stacked on top of each other, are well known. PCT Publication No. WO2015/197709A (Ocado) describes a known storage and fulfilment system in which stacks of bins or containers are arranged within a grid framework structure. The bins or containers are accessed by load handling devices remotely operative on tracks located on the top of the grid framework structure. A system of this type is illustrated schematically in FIGS. 1 to 3 of the accompanying drawings.

As shown in FIGS. 1 and 2, stackable containers, known as bins or containers 10, are stacked on top of one another to form stacks 12. The stacks 12 are arranged in a grid framework structure 14 in a warehousing or manufacturing environment. The grid framework is made up of a plurality of storage columns or grid columns 15. Each grid in the grid framework structure has at least one grid column for storage of a stack of containers. FIG. 1 is a schematic perspective view of the grid framework structure 14, and FIG. 2 is a top-down view showing a stack 12 of bins 10 arranged within the framework structure 14. Each bin 10 typically holds a plurality of product items (not shown), and the product items within a bin 10 may be identical, or may be of different product types depending on the application.

The grid framework structure 14 comprises a plurality of upright members or upright columns 16 that support horizontal members 18, 20. A first set of parallel horizontal grid members 18 is arranged perpendicularly to a second set of parallel horizontal grid members 20 to form a plurality of horizontal grid structures supported by the upright members 16. The members 16, 18, 20 are typically manufactured from metal and typically welded or bolted together or a combination of both. The bins 10 are stacked between the members 16, 18, 20 of the grid framework structure 14, so that the grid framework structure 14 guards against horizontal movement of the stacks 12 of bins 10, and guides vertical movement of the bins 10.

The top level of the grid framework structure 14 includes rails 22 arranged in a grid pattern across the top of the stacks 12. Referring additionally to FIG. 3, the rails 22 support a plurality of load handling devices 30. A first set 22a of parallel rails 22 guide movement of the robotic load handling devices 30 in a first direction (for example, an X-direction) across the top of the grid framework structure 14, and a second set 22b of parallel rails 22, arranged perpendicular to the first set 22a, guide movement of the load handling devices 30 in a second direction (for example, a Y-direction), perpendicular to the first direction. In this way, the rails 22 allow movement of the robotic load handling devices 30 laterally in two dimensions in the horizontal X-Y plane, so that a load handling device 30 can be moved into position above any of the stacks 12.

A known load handling device 30 shown in FIGS. 4 and 5 comprises a vehicle body 32 is described in PCT Patent Publication No. WO2015/019055 (Ocado), hereby incorporated by reference, where each load handling device 30 only covers one grid space of the grid framework structure 14. Here, the load handling device 30 comprises a wheel assembly comprising a first set of wheels 34 consisting a pair of wheels on the front of the vehicle body 32 and a pair of wheels 34 on the back of the vehicle 32 for engaging with the first set of rails or tracks to guide movement of the device in a first direction and a second set of wheels 36 consisting of a pair of wheels 36 on each side of the vehicle 32 for engaging with the second set of rails or tracks to guide movement of the device in a second direction. Each of the set wheels are driven to enable movement of the vehicle in X and Y directions respectively along the rails. One or both sets of wheels can be moved vertically to lift each set of wheels clear of the respective rails, thereby allowing the vehicle to move in the desired direction.

The load handling device 30 is equipped with a lifting device or crane mechanism to lift a storage container from above. The crane mechanism comprises a winch, a tether or cable 38 wound on a spool or reel (not shown) and a grabber device 39. The lifting device or crane mechanism comprise a set of lifting tethers 38 extending in a vertical direction and connected nearby or at the four corners of a lifting frame 39, otherwise known as a grabber device (one tether near each of the four corners of the grabber device) for releasable connection to a storage container 10. The grabber device 39 is configured to releasably grip the top of a storage container 10 to lift it from a stack of containers in a storage system of the type shown in FIGS. 1 and 2.

The wheels 34, 36 are arranged around the periphery of a cavity or recess, known as a container-receiving recess 40, in the lower part of the load handling device. The recess is sized to accommodate the container 10 when it is lifted by the crane mechanism, as shown in FIGS. 5A and 5B. When in the recess, the container is lifted clear of the rails beneath, so that the vehicle or load handling device can move laterally to a different location. On reaching the target location, for example another stack, an access point in the storage system or a conveyor belt, the bin or container can be lowered from the container receiving portion and released from the grabber device.

Thus, upon receipt of a customer order, a load handling device operative to move on the tracks is instructed to pick up a storage bin containing the item of the order from a stack in the grid framework structure and transport the storage bin to an inventory handling station whereupon the item can be retrieved from the storage bin. Where the inventory handling station is used to pick one or more items such an inventory handling station is known as a pick station. Typically, the load handling device transports the storage bin or container to a bin lift device that is integrated into the grid framework structure. A mechanism of the bin lift device lowers the storage bin or container to the pick station. At the pick station, the item is retrieved from the storage bin. Picking can be done manually by hand or by a robot as taught in GB2524383 (Ocado Innovation Limited). After retrieval from the storage bin, the storage bin is transported to a second bin lift device whereupon it is lifted to grid level to be retrieved by a load handling device and transported back into its location within the grid framework structure. A control system and a communication system keeps track of the location of the storage bins and their contents within the grid framework structure. As individual containers are stacked in vertical layers, their locations in the grid framework structure or “hive” may be indicated using co-ordinates in three dimensions to represent the load handling device or a container's position and a container depth (e.g., container at (X, Y, Z), depth W). Equally, locations in the grid framework structure may be indicated in two dimensions to represent the load handling device or a container's position and a container depth (e.g., container depth (e.g., container at (X, Y), depth Z). For example, Z=1 identifies the uppermost layer of the grid, i.e., the layer immediately below the rail system, Z=2 is the second layer below the rail system and so on to the lowermost, bottom layer of the grid.

Equally when stocking the storage system with items or replenishing the inventory of the storage system, items delivered from a supplier is transported to the inventory handling station. Since items are supplied or decanted to replenish stock in the storage system, the inventory handling station is known as a decant station or a supply station. Here, the items are removed from their packaging and depending on the type of item, registered with a unique stock keeping unit or SKU, and placed in storage bins at the decant station. At the decant station, the storage bins are transported to a bin lift device whereupon it is lifted to grid level to be retrieved by a load handling device and transported to a location within the grid framework structure.

WO2017/211640 (Autostore Technology AS) describes a storage system for storing product items, comprising a grid structure, a number of storage bins configured to be stored in vertical compartments in the grid structure, where each storage bin is configured to contain at least one product item, wherein the storage system comprises a picking and/or supply station; and where the storage system comprises a conveyor system configured to convey a storage bin from a first position to a second position and further to a third position. The conveyor system comprises a first, tiltable conveyor configured to convey the storage bin from the first position to the third position via the second position. The picking and/or supply station is provided adjacent to the grid structure. The first and third positions are provided below two different vertical compartments in the grid structure. The tiltable conveyor comprises a hydraulic piston and cylinder mechanism for lowering and elevating a conveyor. The tiltable conveyor supports a storage bin in an inclined position in the second position so allowing items to be manually picked from the storage bin. Once picked, the tiltable conveyor is tilted down and the storage bin is transported to a third position allowing for the storage bin to be retrieved by a load handling device operative on the grid structure.

WO2018/069282 (Autostore Technology AS) describes a picking/supply station assembly for a storage system comprising a grid structure. The picking/supply station assembly comprises a first bin lift device, a second bin lift device and a picking/supply station, wherein the first bin lift device is arrangeable to receive a storage bin from the at least one vehicle at the top level of the grid structure and deliver the storage bin to the picking/supply station. The picking/supply station comprises a bin transport assembly arranged to move the storage bin from the first bin lift device to the second bin lift device; and the second bin lift device is arranged to receive the storage bin from the bin transport assembly and is arrangeable to convey the storage bin to the top level of the grid structure. The bin lift device is arranged in the storage system to receive a storage bin from a vehicle or load handling device at the top level of the grid structure and to convey the bin down in a vertical direction to a supply/picking station arranged at the ground floor in the building wherein the storage system is installed. In use, a first storage bin is initially placed on the lifting arms at the top level of the grid and lowered towards the first conveyor unit. The space between the lifting arms are wide enough to allow the first conveyor unit to pass between them. During passing, the first storage bin will remain on the first conveyor unit, while the lifting arms enters their lowermost position. The first storage bin is then transported out of the first lifting device by the first conveyor unit. After exit of the storage bin from the first bin lift device, the lifting arms may return to the top level for retrieving a second storage bin. The first and second bin lift devices are integrated into the grid framework structure and therefore, the pick station forms an integral part of the grid framework structure.

A similar bin lift mechanism integrated into the grid framework structure to supply a pick station is described in WO 2020/074717 (Autostore Technology AS). WO 2020/074717 (Autostore Technology AS) describes an access station for picking storage containers, comprising: a picking zone, at least one conveyor arranged to transport storage containers from an entry position through said picking zone and to an exit position, wherein the access station comprises: at least one tilting device arranged to tilt a storage container at least in the picking zone. Like, the teaching in WO2017/211640 (Autostore Technology AS), the tilting device tilts a storage container in the picking zone when the access station is to be operated with a picking person, thereby providing the ergonomic benefits of tilting. Storage containers are received at the back side of the access station at an entry position located on an entry conveyor. The entry position is configured for connection to another conveyor, for example a storage system conveyor which transports storage containers to and from the entry position. Upon entering the access station, the entry conveyor transports the storage container in a transport direction to an exit conveyor via a tiltable access conveyor in a picking zone at the front of the access station. Entry and exit of the storage containers to the grid framework structure is via the rear of the access station. The entry position and the exit position may be each connected to a storage system conveyor.

In a storage grid, a majority of the grid columns are storage columns, i.e., grid columns where storage containers are stored in stacks. However, a grid normally has at least one grid column which is used not for storing storage containers, but which comprises a location where the container handling vehicles can drop off and/or pick up storage containers so that they can be transported to a second location (not shown in the prior art figures) where the storage containers can be accessed from outside of the grid or transferred out of or into the grid. Within the art, such a location is normally referred to as a “port” and the grid column in which the port is located may be referred to as a “delivery column”. The storage grids comprise two delivery columns. A first delivery column may for example comprise a dedicated drop-off port where the container handling vehicles or load handling vehicles can drop off storage containers to be transported through the delivery column and further to an access or a transfer station, and a second delivery column may comprise a dedicated pick-up port where the container handling vehicles can pick up storage containers that have been transported through the second delivery column from an access or a transfer station. Storage containers are fed into the access station via the first delivery column and exit the access station via the second delivery column.

As the storage and retrieval system has to function in the environment in which the system operates such as the storage capacity of the grid framework structure, the size and layout of the footprint in which the storage and retrieval system, not one storage and retrieval system are the same. Thus, any peripherals units for decanting or retrieving items to and from the storage containers tend to be of a bespoke construction. This includes the shape and arrangement of the components of the inventory handling station such as the conveyor system, framework structure of the inventory handling station, etc. As the main function of the inventory handling station is to transport storage containers being dropped-off from a drop-off port in the grid framework structure to an access or transfer station where items can be picked from the storage containers, one of the main components of the inventory handling station that needs to be configured to the layout of the storage and retrieval system is the conveyor system. Depending on the transport direction of the storage container, which is generally on the same level, the conveyor system typically comprises multiple adjacent conveyor units to provide a continuous conveying surface from a drop-off/pick-up port to an access station where items can be picked or decanted from the storage containers. One or more of the multiple conveyor units can be orientated so as to provide different transport directions of the storage containers. Examples of the different orientations of the conveyor units include the different transport directions of the storage containers as well as the different orientations of conveying the storage containers by its leading edge along the longest or narrow edge of the storage container, otherwise known as the WEL (wide edge leading) or NEL (narrow edge leading) orientation.

In addition to the different orientations or transport directions of the conveyor system, there are a number of different configurations of conveyor units, including belt conveyor units, skate wheel conveyor units, roller conveyor units. In all of these different conveyor units, there are side walls provided either side of the conveyor system, which define what is termed herein as a ‘conveying channel’. The side walls reduce the likelihood of items falling off the sides of the conveyor system. They achieve this by acting as a barrier so as to hinder the movement of items laterally outwards of the conveying channel relative to a longitudinal axis of the conveying system along which items are intended to be conveyed. The side walls of a conveyor unit are typically made up of a number of side guards, which are positioned adjacent to each another.

Typically, the side guards are made of metal plate and there is often a small gap where the side guards meet each other between adjacent conveyor units.

As the distance between a drop-off or pick-up port and the access station or decant station can extend across multiple grid cells, it is essential that storage containers being conveyed across the conveying system do not become damaged or deflected by any obstructions, particularly, from the side walls of adjacent conveying units.

Storage containers being conveyed along the conveying system may reach junctions which enable the storage containers to travel along a different path. The junctions may be ‘T’ shaped junctions, ‘L’ shaped junctions, or cross junctions. For each type of junction, it is important that the storage containers enter the junction such that they are aligned parallel with the side guards. This ensures that they can change direction smoothly and without risk of colliding with a side guard. At each junction, information can be gleaned regarding the position of the storage container. This is typically achieved by using sensors. At the junction, a sensor (for example a PO2 sensor) can be positioned such that it detects the back of the storage container, and/or a sensor (for example a PO1 sensor) can be positioned such that it detects the front of the storage container. By looking at either the front or the back of the storage container, or both the front and back of the storage container, this gives an indication as to whether the storage container is likely to collide with the side guards of the conveyor system. However, there are problems with using sensors for positional measurement due to their limited visibility range and viewing angles, meaning that sensor information regarding the positional arrangement of a container is limited. To solve this, multiple sensors can be used. A problem with using multiple sensors however is that there may not be sufficient space to accommodate them in the conveyor system. Further, using multiple sensors requires more downtime to analyse the acquired data.

In addition, as electronic commerce (e-commerce) continues to grow and overtake conventional brick and mortar retail practices, many businesses are facing challenges of maintaining or gaining relevance in an online marketplace and being able to compete with prominent players in the space. A typical supply chain involves the storage and retrieval of a large number of different products. For example, e-commerce and retail platforms that sell multiple product lines require systems that are able to store hundreds of thousands of different product lines having different temperature requirements. Different product items need to be maintained at different prescribed temperatures within a storage system, while the product items are stored and/or transported, and/or while orders are fulfilled. Some product items need to be maintained in a chilled or frozen environment to ensure freshness, while other product items can be stored or transported at ambient temperature. For example, where an order of one or more items involves the delivery of food and grocery goods that are of a perishable nature, storage of goods must adhere to strict temperature and environmental requirements, e.g., chilled or frozen temperature. For example, some types of food require a cool temperature environment (typically temperatures between 1° C.-8° C.), some types of food require an even colder temperature environment (typically temperatures lower than −15° C.), and other types of food require a higher temperature environment (typically temperatures above 10° C.).

A conveying system is thus required which overcomes the above problems.

### SUMMARY OF INVENTION

The present invention has mitigated the above problems by providing a conveying system comprising:
a conveyor arranged for conveying a storage container;
a body shaped to comprise a ramp to enable the storage container to move along a first path and a substantially vertical face forming a stopping surface for stopping the storage container from moving along a second path;
   wherein the body is moveable between a retracted position to permit movement of the storage container along the first path of the conveyor and a raised position to prevent movement of the storage container along the second path of the conveyor; the second path being directionally opposite to the first path;
   wherein the body is resiliently biased in the raised position and the bias is overcome by the storage container riding over the ramp.

The present conveying system offers a simple and reliable mechanism for controlling the movement of storage containers. Having a body shaped to comprise the ramp and stopping surface allows the movement of a storage container in one direction and prevent movement of the storage container in an opposing direction. The body is naturally arranged in a raised position. In particular, the body is mechanically driven such that the weight of a storage container compresses the body when the storage container rides over the ramp. As the body is compressed, they move into a retracted position to allow the movement of the storage container moving in a first path over the ramp and stopping surface. If the storage container moves in a second path which is directionally opposite to the first path, the storage container drives into the stopping surface, which is naturally in a raised position, which prevents it from travelling further along the second path. The storage container may move in a second path along a second conveyor, or the storage container may move in a second path along a first conveyor which is configured to operate in reverse thus moving the storage container in an opposing direction to the first direction.

The simple and reliable mechanism means it is not necessary to have an electrical supply to operate control the movement of a storage container along a particular direction because the ramp and stopping surface are not electrically driven. Neither is it necessary to have a compressed air supply as the ramp and stopping surface are not changeable from a raised position to a retracted position by pneumatics. Further, it is not necessary to use sensors to control the movement of the storage containers on the conveying system. Typically, using only sensors for controlling the movement of one or more storage containers causes problems where the storage containers can overrun or underrun their intended stop positions. Using the present conveying system provides better control of the stopping position of the storage containers by providing a physical barrier.

Another advantage of the conveying system is that it may be operated at chilled and freezer temperatures. The temperature of a chilled environment may be between 0° C. and 5° C. The temperature of a freezer environment may be between −18° C. and −23° C. In freezer environments, electrical devices perform less effectively owing to water in the devices freezing and expanding which can cause damage to delicate components and circuitry. There are also problems using pneumatic systems when the surrounding air is cold because lubricants in the pneumatic control valves can become more viscous and small orifices can quickly become blocked by ice. Using a simple ramp and stopping surface arrangement which is mechanically driven and has few moving parts mitigates the problems associated with electrical devices and pneumatic systems at low temperatures.

For the present conveying system to operate, the ramp and stopping surface must be resiliently biased in a raised position, i.e., the ramp and stopping surface's natural position is in an upwards position. This allows the ramp and stopping surface to be compressed into a retracted position as a storage container rides over the ramp in one direction. However, if the storage container is travelling in the opposite direction, the storage container is stopped by the stopping surface which is in the raised position. This ensures that storage containers travel in the desired direction around the conveying system, and if not, the storage containers are stopped by the stopping surface. Since the location of the stopping surface is known, a storage container stopped by the stopping surface can be easily found and, if desired, removed from the conveying system.

The stopping surface has a dual purpose of both stopping a storage container moving along a path and guiding a storage container stopped by the stopping surface and then driven along a path perpendicular to the original path. The stopping surface may comprise a flat, smooth surface to allow a storage container to slide sideways along the stopping surface in a path perpendicular to its original path. The stopping surface, for example, may be made of metal or made be made of plastic.

The ramp of the body may have an angle of inclination of less than 45°. Preferably the ramp has an angle of inclination of between 10° and 40°, more preferably between 15° and 25°, more preferably between 15° and 20°. The shallower the angle of the ramp, the less initial force is required for a storage container to pass over the ramp. Thus, an angle of approximately 18° offers a sufficient gradient to provide some resistance to movement whilst also allowing a storage container with enough force (specifically mass and/or acceleration) the ability to ride over the ramp.

Optionally, the body comprising the ramp and the stopping surface is formed as a single, integral piece, e.g., machining, injection moulding, etc. Alternatively, the body can be formed as separate parts or pieces that are joined or assembled together to form the ramp and the stopping surface. Optionally, the body further comprises a plate, said plate having a first face defining the stopping surface and a second face defining a mounting face, said ramp being mounted to the mounting face. The ramp being mounted to the mounting face of the plate such that the ramp inclines upwardly towards the mounting face of the plate.

Optionally, the conveyor comprises at least one roller, and wherein a portion of the at least one roller comprises the body. In other words, the body comprising the ramp and the stopping surface may be incorporated into a roller of the conveyor. For example, the body comprising the ramp and stopping surface may be positioned between a pair of rollers, or a roller may be positioned between a pair of bodies comprising the ramp and stopping surface. Alternatively, a plurality of rollers may be alternately arranged between three, four or five ramps and stopping surfaces. The arrangement of having the body comprising the ramp and stopping surface positioned between a pair of rollers is a less complex arrangement than having a roller between a pair of bodies comprising the ramps and blade stops. The arrangement of having the body positioned between a pair of rollers may be arranged such that the pair of rollers and the body occupies a space which is the same size and shape as a standard roller of a conveyor.

Optionally, the body is positioned centrally along the width of the conveyor. This is the simplest arrangement of the ramp and stopping surface. The body comprising the ramp and the stopping surface may extend across a portion of the width of the conveyor, for example one quarter, one third, half, two thirds, three quarters of the width of the conveyor. Alternatively, the body comprising the ramp and the stopping surface may extend across the whole width of the conveyor.

The body comprising the ramp and the stopping surface may be moveably attached to a roller bracket to define a blade stop unit, said roller bracket being configured to support one or more rollers. The roller bracket may extend across the width of the body comprising the ramp and the stopping surface. The one or more rollers may extend from the roller bracket. The body comprising the ramp and the stopping surface move vertically with respect to the roller bracket. Specifically, the blade stop unit further comprises a carriage, the body comprising the ramp and the stopping surface being mounted to the carriage, said carriage being moveably attached to the roller bracket. The carriage may be moveably attached to the roller bracket by rails. The carriage may support free ends of the body comprising the ramp and the stopping surface to ensure that the ramp and stopping surface are compressed evenly across the width of the ramp and stopping surface as a storage container rides over the ramp and compresses the ramp and stopping surface from the raised position to the retracted position.

The at least one blade stop unit comprises a resilient member. Optionally, the at least one blade stop unit comprises one or more springs for resiliently biasing the ramp and the stopping surface in the raised position. Springs are easily available and are a cost effective way of providing resiliency. Optionally, the at least one blade stop unit comprises a compression spring. Using a compression spring ensures that the blade stop unit returns to the raised position after being compressed under the weight of a storage container riding over the blade stop unit via the ramp. Specifically, the one or more springs may be spring plungers. Spring plungers are spring elements comprised of a ball and a pin and are also referred to as ball catches. The one or more springs may be rated to compress under the weight of a storage container having a weight equal to or greater than 4 kg. This spring rating means that the ramp of the blade stop unit will compress under the weight of an empty storage container as well as a storage container holding one or more items. Alternatively, the one or more springs may be rated to compress under the weight of a storage container having a weight equal to or greater than 5 kg, 6 kg, 7 kg, 8 kg, 9 kg, 10 kg or greater than 10 kg. In this case, the ramp of the blade stop unit will compress only under the weight of a storage container holding one or more items, but not under the weight of an empty storage container. Thus, the springs can be tailored to suit the type of storage container (for example, metal, plastic etc.) and the type of items (i.e., heavy or light items) to be held or stored in the storage containers. The one or more springs may be interposed between the ramp and the stopping surface (as a single unit), and the roller bracket. This arrangement allows the one or more springs to be easily replaced.

Optionally, the blade stop and the ramp are formed as separate parts. The benefit of the ramp and blade stop being formed as separate parts is that they may be formed from different materials. The blade stop may, for example, be formed from a metal, such as stainless steel, therefore providing a stronger surface onto which the storage container can butt up against. Alternatively, the blade stop may be formed from plastic. The ramp may, for example, be formed from a plastic, such as polyethylene, which is a durable material. The polyethylene ramp may be coated in a nylon coating which has a low coefficient of friction.

Optionally, the at least one blade stop unit may be arranged between adjacent rollers of a conveyor. The at least one blade stop unit may be fixedly connected to the side walls of the conveyor. The at least one blade stop unit may be connected to the sidewalls by a beam or fixed rod. In this arrangement, the at least one blade stop can be retrofitted to a conveyor in order to control the movement of a storage container along the conveyor.

The blade stop unit may comprise an actuator for locking the ramp and stopping surface into the raised position or the retracted position. The actuator may be electrical and may act as a switch to electrically lock the ramp and stopping surface in the raised or retracted position.

The actuator may be controlled by a control system. The control system may also control the drive mechanism of the conveyor.

Optionally, the conveying system may further comprise:
i) a drive mechanism for driving movement of the conveyor;
ii) a control system for controlling the drive mechanism; and
iii) at least one position sensor for detecting the position of the storage container along the conveyor;
wherein the control system is configured to control movement of the conveyor in response to one or more signals from the at least one sensor.

The drive mechanism may comprise a motor and a drive belt driven by the motor. The drive belt may drive rollers or a belt of the conveyor. The at least one position sensor may be located to detect the position of a storage container before the ramp and stopping surface. The at least one sensor may send information on the position of the storage container with respect to the ramp and stopping surface to the control unit. When the at least one sensor senses the storage container nearing the blade stop unit, it sends this information to the control unit and the control unit may instruct the conveyor to slow down such that the storage container stops before it reaches the ramp and stopping surface. The sensors may be capacitive sensors that detect the presence of the storage container at the ramp and stopping surface and stop the conveyor from moving the storage container. The conveying system may comprise one, two, three or four sensors. If the conveying system comprises two sensors, both sensors may be used for sensing the presence of the front of the storage container as it moves towards the ramp and stopping surface. Alternatively, one sensor may be used for sensing the presence of the front of the storage container as it moves towards the gate and the other may be used for sensing the back of the storage container. In this application, the terms ‘front’ and ‘back’ of the storage container mean the front side or back side of the storage container when the storage container is moving in its original path along the first conveyor towards the ramp and stopping surface. Thus, the ‘front’ and ‘back’ of the storage container may not necessarily be at the front or back of the storage container after the storage container changes direction, e.g., if the storage container is travelling along a second path.

The control system may control the actuator of the at least one blade stop unit such that, in response to a signal from the one or more position sensors, the control system locks the ramp and stopping surface in the raised position so one or more storage containers are not permitted to travel along the path in which they were moving because the ramp cannot be compressed down into the retracted position. Alternatively, the control system may control the actuator of the at least one blade stop unit such that, in response to a signal from the one or more position sensors, the control system locks the ramp and stopping surface in the retracted position so that one or more storage containers are permitted to travel along the conveyor in either direction. The control system may in addition instruct the conveyor to slow down in response to a signal from the one or more position sensors.

The at least one blade stop unit may be defined as the first blade stop unit, and the conveying system may further comprise a second blade stop unit, the second blade stop unit comprising a second body comprising a ramp and a stopping surface, wherein the second blade stop unit is arranged such that the stopping surface of the second blade stop unit faces the stopping surface of the first blade stop unit. In this arrangement, a storage container may ride over the ramp of the first blade stop unit and be prevented from moving along the same path by the stopping surface of the second blade stop. When the storage container has passed over the ramp of the first blade stop, the ramp returns to its original raised position and thus the storage container is confined in a space between the first blade stop unit over which it traversed and the second blade stop unit which stopped the storage container from moving along the path. Thus, the storage container can be easily located and, if necessary, removed from the conveyor.

Optionally, said conveyor is defined as a first conveyor, wherein the conveying system further comprises a second conveyor arranged for moving one or more storage containers along a third path substantially perpendicular to the first path of the first conveyor, wherein the second conveyor cooperates with the first conveyor at a junction where the third path intersects the first path to define an entrance of the second conveyor from the first conveyor, the first and second blade stop units being spaced apart to guide one or more storage containers along the third path through the entrance of the second conveyor. The blade stop units therefore provide alignment of the storage container and enables the storage container to be conveyed in an alternative direction. The stopping surface of the second blade stop unit stops the storage container. The first blade stop returns to a raised position after the storage container has moved over the ramp of the first blade stop. Therefore, the storage container is retained within the space between the stopping surfaces of the first blade stop unit and the second blade stop unit. The space between the stopping surfaces is equal to the depth or width of the storage container. The stopping surfaces of the first blade stop unit and the second blade stop unit may then be used as guiding surfaces to guide the storage container along the third path which is perpendicular to the first path. The first conveyor may also be termed an ‘access conveyor’ and the second conveyor may also be termed an ‘exit conveyor’.

Optionally, the conveying system further comprises a conveying unit, the conveying unit comprising the first blade stop unit, the second blade stop unit and a series of rollers, the first blade stop unit and the second blade stop unit being spaced apart by a series of rollers such that a storage container is guided by the stopping surfaces of the first blade stop unit and the second blade stop unit. Specifically, the storage container touches both the stopping surface of the first blade stop unit and the stopping surface of the second blade stop unit, thereby enabling the stopping surfaces to act as guiding surfaces. The distance between the stopping surface of the first blade stop unit and the stopping surface of the second blade stop unit may be equal to at least one external dimension of a storage container. The external dimension may be the depth of width of the storage container. The conveyor unit may form a junction where the first conveyor meets the entrance of the second conveyor. This arrangement is particularly advantageous because when the storage container is stopped at the stopping surface of the second blade stop unit, the storage container's leading edge (i.e., front side) is square with the stopping surface of the second blade stop unit. The storage container also touches the stopping surface of the first blade stop unit. Therefore both the stopping surface of the first blade stop and the stopping surface of the second blade stop unit guide the storage container along a third path which ensures that when the storage container is moved along the second conveyor the leading edge or front side of the storage container is parallel with the side guards of the second conveyor and therefore does not collide with the side guards of the second conveyor. The first conveyor and the second conveyor may each comprise belt(s), chain(s) and/or rollers.

The conveying system may further comprise a third conveyor for conveying the storage container along the second path parallel and opposite to the first path. The third conveyor may be adjacent the entrance of the second conveyor. Thus, in this arrangement, a storage container being conveyed by the third conveyor along a second path rides over the ramp of the second blade stop unit and abuts the stopping surface of the first blade stop unit. A storage container can therefore approach the first blade stop unit and the second blade stop unit and/or the conveyor unit from either direction allowing a storage container to come from two different locations. The third conveyor may also be termed a ‘second access conveyor’.

Optionally, the conveying system further comprises a directional change mechanism at the junction between the second conveyor and the first conveyor for moving the storage container from the first conveyor to the second conveyor and/or between the second conveyor and the third conveyor for moving the storage container from the third conveyor to the second conveyor. The directional change mechanism may comprise a pushing or shunting device arranged to physically push the storage container positioned at a junction where the first conveyor meets the second conveyor, from the first conveyor to the second conveyor. The pushing or shunting device may be a block controllable by a control unit, such that when the barrier is in the closed and locked configuration, the control unit can instruct the block to shunt the storage container sideways from the first conveyor to the second conveyor. The pushing or shunting device moves the storage container without changing the orientation of the storage container. The pushing or shunting device also moves the storage container in such a way so as to ensure that the storage container moves in line with the second conveyor, and therefore does not change the orientation of the storage contain from its position at the junction abutting the barrier of the gate. Alternatively, the directional change mechanism may be a directional change conveyor unit, wherein the directional change conveyor unit comprises a lifting mechanism configured to be lowered or raised relative to the conveyor in order to lower or raise the storage container when positioned at the junction and drag or pull the storage container from the conveyor onto the second conveyor. The directional change mechanism may comprise one or more roller(s) and/or belt(s) and/or chain(s) laterally disposed between or which interdigitate between the rollers of the first conveyor and are arranged to be driven transversely to the transport direction of the conveyor unit. The directional change conveyor unit is lowered or raised by a lifting mechanism relative to the rollers of the conveyor such that in the raised position, the directional change conveyor unit is in contact with a storage container causing the directional change conveyor unit to drag or pull the storage container from the conveyor onto the second or third etc. conveyor. The directional change conveyor unit may be controllable by a control unit such that it may be switched on to move the storage container onto the second conveyor, or it may be switched off to halt the movement of the storage container so that the storage container does not move onto the second conveyor, and therefore the storage container remains at the junction or continues along the same path as before. The directional change conveyor unit may be switched off, for example, if there is a fault with the storage container. The control system may operate the conveyors, the directional change mechanism and, if present, the actuators of the blade stop units. For example, sensors positioned on the third conveyor before the second blade stop unit may sense the presence of a storage container and send a signal to the control system. The control system may then instruct the drive mechanism of the third conveyor to stop such that the storage container stops before the second blade stop unit. The control system may also instruct the actuator to lock the second blade stop unit in the raised position such that if the storage container overruns its intended stop position, it will be stopped by the locked ramped of the second blade stop unit. Then sensors positioned on the first conveyor before the first blade stop unit may sense the presence of a second storage container and send a signal to the control system which may let the second storage container ride over the first blade stop unit (i.e. the first blade stop unit is in an unlocked raised position, or a locked retracted position) into the junction between the first blade stop unit and the second blade stop unit. A position sensor located between the first blade stop and the second blade stop detects the presence of the second storage container after it has travelled over the first blade stop unit and sends a signal to the control unit which then instructs the directional change mechanism to move the second storage container from the junction onto the second conveyor.

The movement of storage containers around the conveying system may be based on a timing regime. For example, the control system may instruct the movement of three storage containers from the first conveyor over the first blade stop unit and onto the second conveyor, followed by three storage containers from the second conveyor over the second blade stop unit and onto the second conveyor. Since the control system comprises a memory in which it stores the time it takes for each storage container to move from the first or third conveyor into the junction and onto the second conveyor, the actuators (if present), the conveyors and the directional change mechanism can be set to automatically switch on and off based on these timings. Thus, in this set-up, it may not be necessary to have sensors present in the conveying system.

The conveying system of the present invention may be used as part of an inventory handling system or as part of any such other similar conveying system.

### DESCRIPTION OF THE DRAWINGS

Further features and aspects of the present invention will be apparent from the following detailed description of an illustrative embodiment made with reference to the drawings, in which:

FIG. 1 is a schematic diagram of a grid framework structure according to a known system;

FIG. 2 is a schematic diagram of a top down view showing a stack of bins arranged within the framework structure of FIG. 1;

FIG. 3 is a schematic diagram of a system of a known load handling device operating on the grid framework structure;

FIG. 4 is a schematic perspective view of the load handling device showing the lifting device gripping a container from above;

FIGS. 5A and 5B are schematic perspective cut away views of the load handling device of FIG. 4 showing (FIG. 5A) a container accommodating a container receiving space of the load handling device and (FIG. 5B) the container receiving space of the load handling device;

FIG. 6 is a schematic view of one configuration of a conveyor system;

FIG. 7 is an exploded view of a blade stop unit;

FIG. 8 is the perspective view of the blade stop unit of FIG. 7 in an assembled state;

FIG. 9 is a side view of the blade stop unit of FIGS. 7 and 8 in a raised position;

FIG. 10 is a side view of the blade stop unit of FIGS. 7 and 8 in a retracted position;

FIG. 11 is an exploded perspective view of a roller blade stop unit comprising the blade stop unit of FIGS. 7 and 8 incorporated into a roller;

FIG. 12 is a perspective view of the roller blade stop unit of FIG. 11 in an assembled state;

FIG. 13 is a top view of a conveyor unit comprising a pair of roller blade stop units of FIGS. 11 and 12;

FIG. 14 is a perspective view of the conveyor unit of FIG. 13;

FIG. 15 is a side view of the conveyor unit of FIGS. 13 and 14;

FIG. 16 is a top view of a conveyor unit comprising two blade stop units each attached to the frame of the conveyor unit by a pair of beams or fixed rods;

FIG. 17 is a schematic side view showing a conveying system comprising the conveyor unit of FIGS. 13, 14 and 15, showing both the ramp and stopping surface of the first blade stop unit and the ramp and stopping surface of the second blade stop unit in a raised position;

FIG. 18 the conveying system of FIG. 17 showing the first blade stop unit in the retracted position and the second blade stop unit in the raised position;

FIG. 19 is a schematic side view of the conveying system of FIG. 17 in which a storage container is moving towards the conveyor unit;

FIG. 20 is a schematic side view of the conveying system of FIG. 17 in which the storage container is riding over the first blade stop unit of the conveyor unit;

FIG. 21 is a schematic side view of the conveying system of FIG. 17 in which the storage container is positioned in the conveyor unit between the first blade stop unit and the second blade stop unit;

FIG. 22 is a top view of an alternative conveying system comprising a first, second and third conveyor and a conveyor unit;

FIG. 23 shows a second container moving along the third conveyor towards the conveyor unit;

FIG. 24 shows the second container on the conveyor unit between the first blade stop unit and the second blade top unit;

FIG. 25 shows the second container moving away from the conveyor unit onto the second conveyor;

FIG. 26 shows the second container moving on the second conveyor;

FIG. 27 shows the first container moving from the first conveyor over the first blade stop unit onto the conveyor unit;

FIG. 28 shows the first container positioned on the conveyor unit between the first blade stop unit and the second blade stop unit.

### DETAILED DESCRIPTION

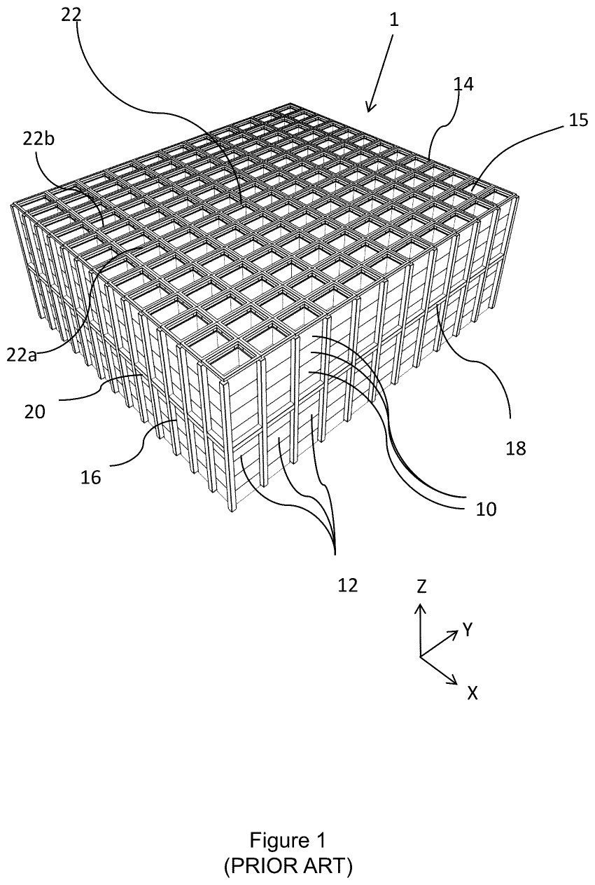

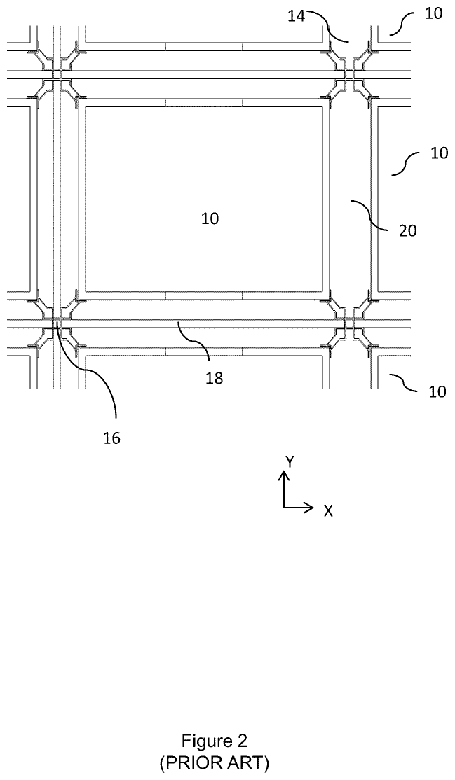

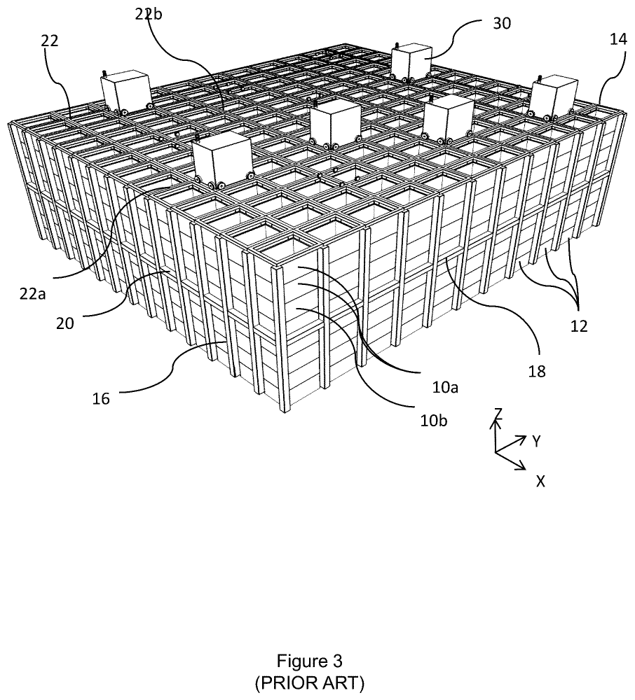

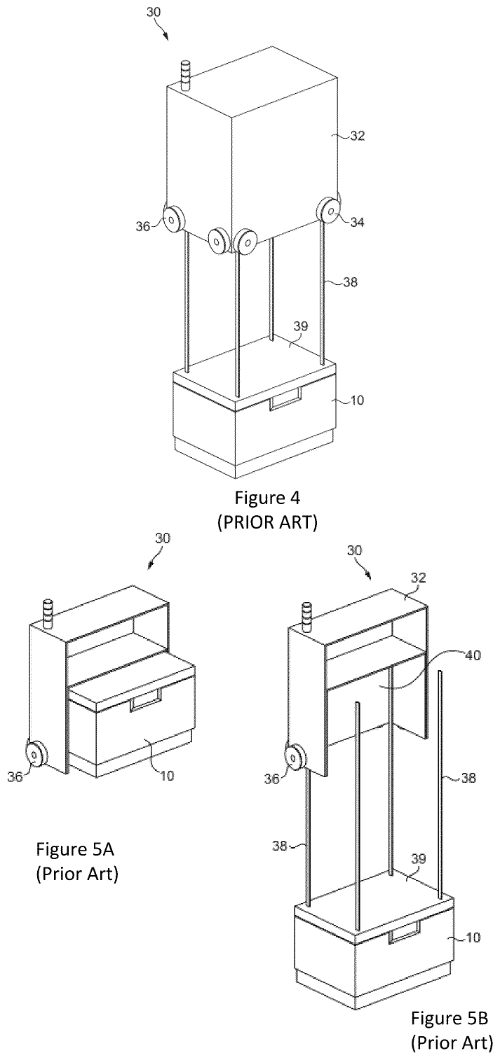

It is against the known features of the storage system such as the grid framework structure and the load handling device described above with reference to FIGS. 1 to 5, the present invention has been devised. In a typical fulfilment centre, a large variety of items, such as grocery items are stored in storage bins or containers and the storage bins or containers are stored in one or more stacks in the grid framework structure, more specifically within grid columns. The grid columns are formed by a plurality of upright columns or vertical uprights arranged as vertical storage locations. Individual containers may be stacked in vertical layers, and their locations in the grid framework structure or “hive” may be indicated using co-ordinates in three dimensions to represent the load handling device or a container's position and a container depth (e.g., container at (X, Y, Z), depth W). Equally, locations in the grid framework structure may be indicated in two dimensions to represent the load handling device or a container's position and a container depth (e.g., container depth (e.g., container at (X, Y), depth Z). For example, Z=1 identifies the uppermost layer of the grid framework structure, i.e., the layer immediately below the rail system, Z=2 is the second layer below the rail system and so on to the lowermost, bottom layer of the grid framework structure. A majority of the grid columns in the grid framework structure are storage columns.

An order fulfilment system comprises a bin or container filling station, a storage and retrieval system, a plurality of order picking stations, an order container handling and sortation system and dispatch facilities. Details of an order fulfilment system are described in WO 2014/203126 (Ocado Innovation Limited) details of which are incorporated herein by reference. In the order fulfilment system such as the one described in WO 2014/203126 (Ocado Innovation Limited), individual containers are stored within the storage and retrieval system and can contain one or more items, which may be identical. The storage and retrieval system comprises the grid framework structure where storage bins or containers are stored in grid columns.

To pick an order comprising different items, it is often necessary to retrieve items from multiple source containers. Such containers can be retrieved from the storage and retrieval system and brought to a desired order picking system. Specific containers required for fulfilment of orders are accessed by a robotic load handling device operative on the grid framework structure. The robotic load handling device preferably comprises a control unit which receives control signals from a radio communications unit of a control system or a central control system concerning information on where to pick up and deliver a storage bin or container in the grid framework structure. The control system controls the operation of one or more robotic load handling devices operative on the grid framework structure and comprises one or more processors, a memory (e.g., read only memory and random access memory) and a communication bus. The memory can be any storage device commonly known in the art and includes but is not limited to a RAM, computer readable medium, magnetic storage medium, optical storage medium or other electronic storage medium which can be used to store data and accessed by the one or more processors.

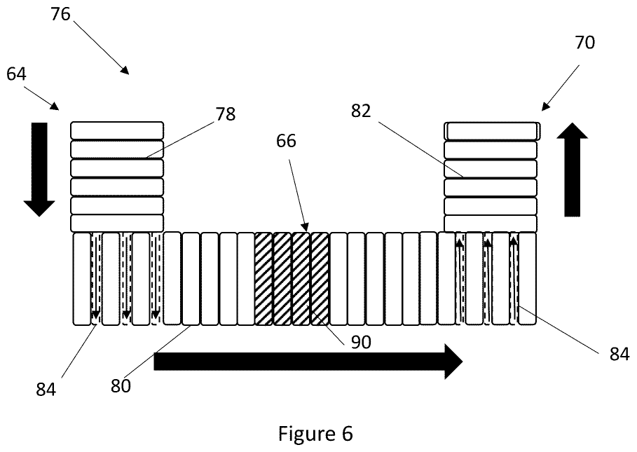

Conveying systems move storage containers in and out of the grid framework structure. FIG. 6 shows an example of a type of conveying system. The conveying system 76 transports a storage bin or container from a supply zone to an access station and subsequently to the buffer zone 70 where the storage bin or container is vertically accumulated to be picked up by a load handling device operative on the grid framework structure and either returned to its original destination in the grid framework structure or a new destination in the grid framework structure. The conveying system 76 comprises multiple conveyors units, namely an entry conveyor unit 78, at least one access conveyor unit 80 and an exit conveyor unit 82, and arranged to transport the storage bin or container from the supply zone 64 to the buffer zone 70 via the access station 66. The storage bin or container is paused at the access station 66 which functions as a pick station or a restocking station. The multiple conveyor units are arranged adjacent to each other or connected to each other such that a storage bin is transported from one conveyor unit to an adjacent conveyor unit as it travels along the conveying system 76.

The entry conveyor unit 78 is arranged in the supply zone 64. Each conveyor unit may comprise any suitable arrangement of belt(s), chain(s) and/or rollers well known in the art of conveyor systems. In the embodiment shown in FIG. 6, the storage bin or container travels in a U-shaped path along the conveying system 76, i.e., the storage bin changes direction twice along the conveyor system. The at least one access conveyor unit 80 extends between the entry conveyor unit 78 and the exit conveyor unit 82 and can comprise multiple conveyor units arranged adjacent each other in the horizontal plane such that a storage bin or container is transported from one conveyor unit to an adjacent conveyor unit along the access conveyor unit 80. Typically, one or more of the rollers of the at least access conveyor unit 80 and optionally, the entry conveyor unit 78 and/or exit conveyor unit 82 comprises an integrated driving motor (not shown), whilst the remaining rollers may be connected by belts (not shown) to the driving roller, or they may be passive.

However, in the conveyor arrangement shown in FIG. 6, when the storage bin changes path from the access conveyor unit 80 to the exit conveyor 82, the storage bin may not move perpendicularly from the access conveyor unit 80 resulting in the storage bin colliding with the side guards of the exit conveyor and potentially causing a building-up of storage bins on the exit conveyor. Further, in the conveyor arrangement shown in FIG. 6, the access conveyor unit 80 may extend for several metres and it may be difficult to stop a storage bin travelling along the access conveyor at a specific position.

The present invention addresses these problems by providing a conveying system comprising a conveyor for conveying a storage container along a path, and a body comprising a ramp and stopping surface forming part of a blade stop unit. The ramp enables a storage container to move in a first direction or path and the stopping surface stops a storage container from moving in a second direction or path where the second direction is directionally opposite the first direction. Both the ramp and the stopping surface are resiliently biased in a raised position to prevent the storage container moving in the second direction. The ramp and the stopping surface are moveable to a retracted position as a storage container rides over the ramp thereby permitting movement of the storage container in a first direction.

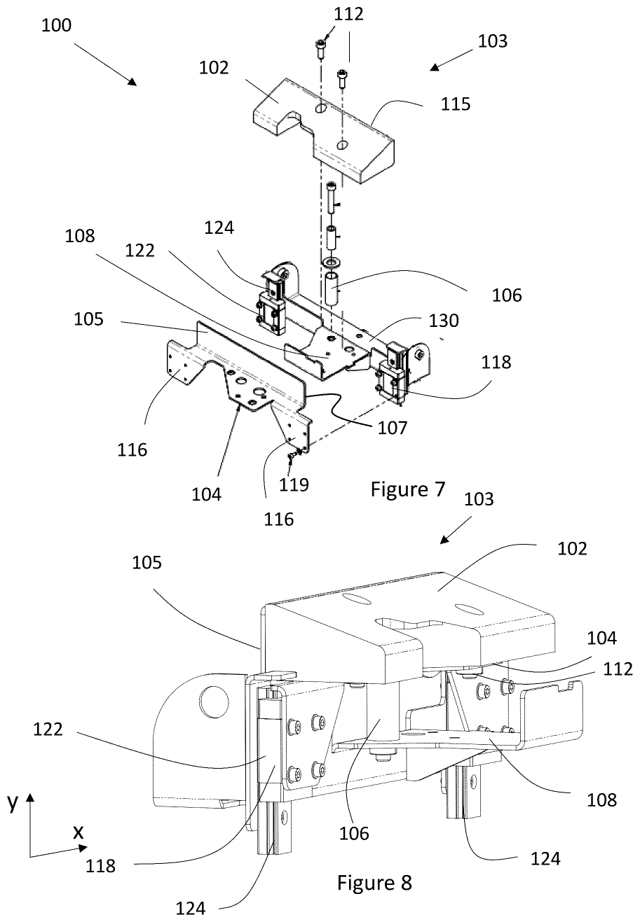

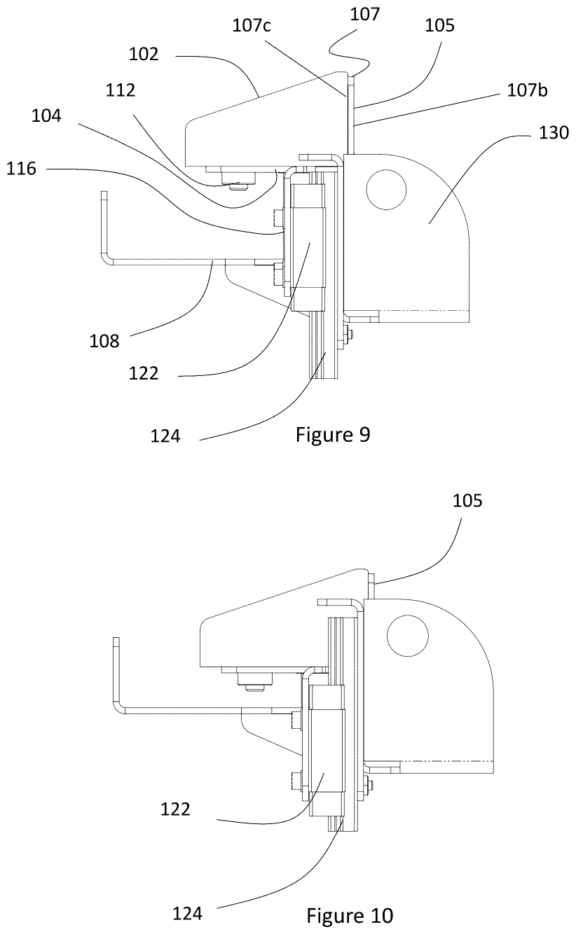

The body 103 comprising the ramp and stopping surface of the present invention are shown as part of a blade stop unit in FIGS. 7 and 8. In the foregoing description of the present invention, the body comprising the ramp and the stopping surface is described as a ramp and stopping surface. However, whilst body 103 comprising the ramp and the stopping surface can be formed as a single piece, the blade stop unit 100 of FIGS. 7 and 8 shows the body 103 comprising the ramp 102 and the stopping surface 105 formed as separate parts. Specifically, the stopping surface 105 is part of a blade stop 104. The blade stop 104 may be formed from metal, whilst the ramp may be formed from plastic. The ramp 102 is mounted to the blade stop 104 by screws 112 such that the stopping surface 105 of the blade stop is adjacent and butts up against a vertical end 115 of the ramp 102. In the particular example shown in FIG. 7, the blade stop 104 comprises a plate 107 having as first face 107b defining the stopping surface 105 and an opposing second face 107c defining a mounting face 107c (see FIG. 9). The vertical end 115 of the ramp is mounted to the second face 107c of the plate such that the ramp inclines upwardly towards the mounting face 107c of the plate 107. The plate 107 can be a separate piece attached to the blade stop 104. In the particular example shown in FIG. 7, the blade stop 104 and the plate 107 are formed as a single piece, e.g., formed from a sheet metal blank having one or more bends. The blade stop unit 100 also comprises a roller bracket 130. The ramp 102 and the stopping surface 105 are moveably attached to the roller bracket 130. In particular, the ramp 102 and the stopping surface 105 are moveably attached to a mounting surface 108 which is integrally formed with the roller bracket 130. The mounting surface 108 extends to provide a substantially horizontal surface. An actuator (not shown) may also be attached to the mount 108. The blade stop 104 is mounted to the mounting surface 108 by the resilient member 106. In this case, the resilient member 106 is a spring, for example, a compression spring. The spring is biased such that the ramp 102 and blade stop 104 are in a raised position, as shown in FIG. 8.

The blade stop unit 100 also comprises a pair of linear guides 118. Each linear guide 118 comprises a carriage 122 and a vertically extending rail 124, the carriage being moveable along the rail 124. Each rail 124 is structurally integrated to the roller bracket 130 such that each carriage 122 is moveably attached to the roller bracket 130. Thus the roller bracket 130 provides a fixed base allowing vertical movement of the ramp 102, stopping surface 105 and carriages 122. Each linear guide 118 is positioned to support the vertical movement of the free ends of the ramp 102 and the blade stop 104. The carriage 122 is guided substantially vertically along the rail 124 between a raised position and a retracted position. Specifically, the blade stop 104 comprises a pair of vertically orientated projections 116 and each vertically orientated projection is fixed by screws 119 to a carriage 122 of each of the linear guides 118. Since the pair of carriages 122 of the linear guides 118 are vertically moveable along the rails of the linear guides, the blade stop 104 (and therefore the stopping surface 105) and the ramp 102 are vertically moveable. The arrangement of the resilient member 106, the blade stop 104 and the linear guides 110 is such that when a force pushes down on the ramp 102, the resilient member 106 is compressed so that the ramp and the blade stop 104 are moved in a downwards direction guided by the linear guides 118. The movement of the carriage 122 is more clearly shown in FIGS. 9 and 10.

FIG. 9 is a side view of the blade stop unit in the raised position in which the resilient member 106 is in an un-compressed (i.e., relaxed) state. In this state, the carriage 122 is at or near the top of the rail 124 of the linear guide 118. FIG. 10 is a side view of the same blade stop unit as FIG. 9 but the blade stop unit is in the retracted position. In this state, the resilient member 106 is in a compressed state and the carriage 122 is at or near the bottom of the rail 124 of the linear guide 118. Thus, free ends of the ramp 102 and blade stop 104 are equally supported vertically by the linear guides 118.

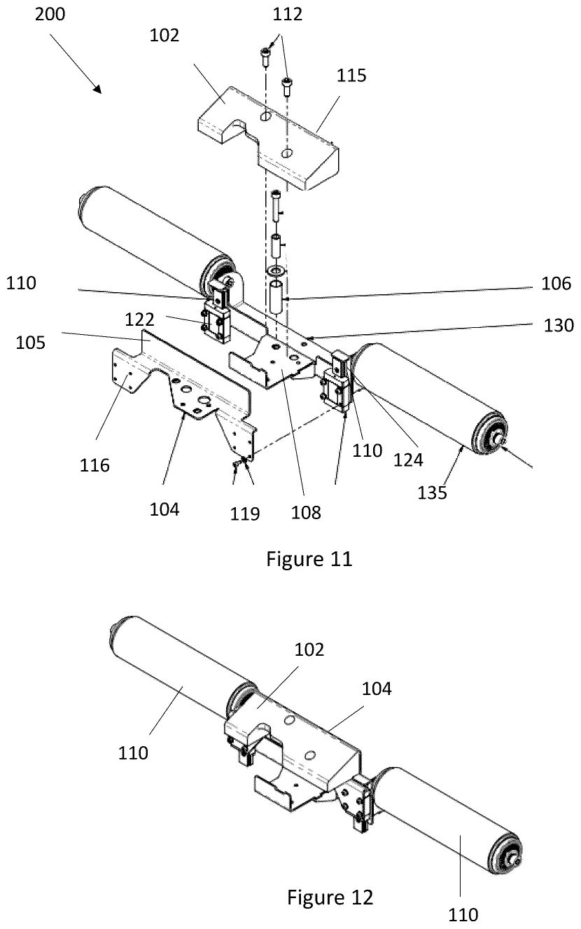

There are several ways in which the blade stop unit 100 can be arranged in a conveying system. In one arrangement, as shown in FIGS. 11 and 12, the blade stop unit is incorporated into a roller. A roller 135 is attached to each end of the roller bracket 130 of the blade stop unit 100 such that the blade stop unit 100 is located centrally between two rollers 135. The combination of the blade stop unit 100 and the two rollers 135 extending from the blade stop unit 100 is called a roller blade stop unit 200. The rollers 135 support a storage container as it rides over the ramp of the blade stop assembly. The rollers also allow for easier movement of the storage container as it rides over the ramp of the blade stop unit. In particular, the rollers rotate clockwise as the storage container passes over them. The roller blade stop units shown in FIGS. 11 and 12 can be used adjacent to conveyors comprising belts, chains or rollers. For example, the arrangement shown in FIGS. 11 and 12 can be positioned between two belt conveyors, or two chain conveyors or two roller conveyors.

FIGS. 11 and 12 shows an arrangement of the roller blade stop unit 200 which comprises a single blade stop unit 100 and two rollers 135. However, it is also possible to have an arrangement of the roller blade stop unit 200 comprising two blade stop units 100 and a single roller 135 between the two blade stop units 100. It is also possible to have an arrangement of roller blade stop unit 200 comprising three blade stop units 100 and two rollers 135 with one roller positioned between a first blade stop unit and a second blade stop unit, and the second roller positioned between the second blade stop unit and a third blade stop unit.

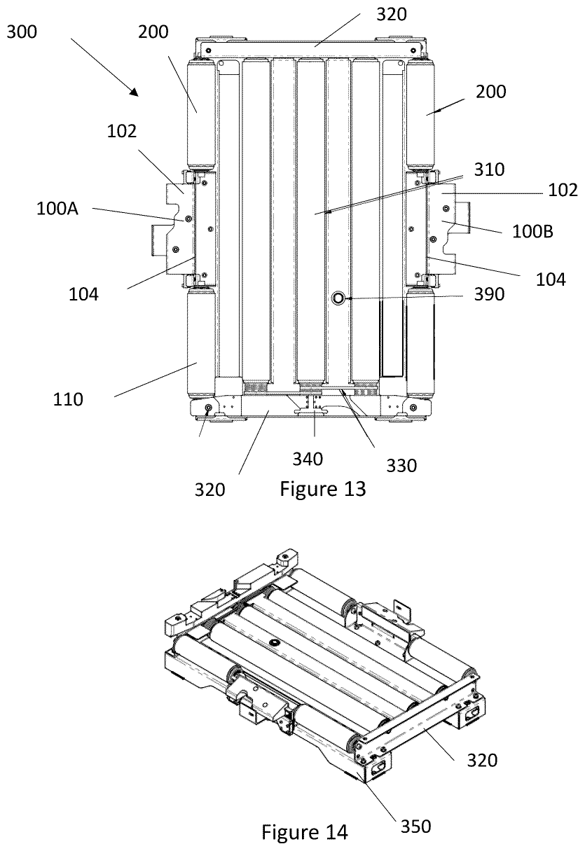

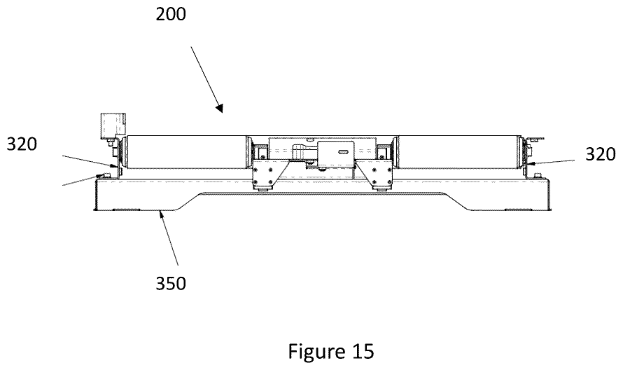

A pair of roller blade stop units 200 can be combined into a conveyor unit which can be placed between two conveyors. An example of a conveyor unit 300 is shown in FIGS. 13, 14 and 15. The conveyor unit 300 comprises a pair of roller blade stop units 200 and a series of rollers 310 between the pair of roller blade stop units 200. Thus, the blade stop units 100A and 100B are spaced apart from each other. The second blade stop unit is arranged such that the stopping surface 105 of the second blade stop unit 100B faces the stopping surface 105 of the first blade stop unit 100A. As shown in FIG. 14, the ramp 102 of the first blade stop unit 100A inclines upwards towards the series of rollers 310 whilst the ramp of the second blade stop unit 100B inclines downwards away from the series of rollers 310. The rollers 310 are moveable by a drive belt 330. In FIGS. 13 and 14, there are three rollers 310 between the pair of roller blade stop units 200. The number of rollers 310 between the roller blade stop units 200 may be two rollers, or four rollers, or five, six, seven or eight rollers for example. However, the space between the stopping surfaces 105 of the first blade stop unit 100A and the second blade stop unit 100B of the roller blade stop units 200 is be equal to the depth d (as shown in FIG. 21) of a storage container. Each end of the rollers 310 and the roller blade stop units 100A, 100B is connected to a frame 320. One side of the frame 320 comprises a drive mechanism comprising a motor 340 and the drive belt 330 for moving the series of rollers 310. The frame 320 is affixed to a conveyor mount 350 which is positioned below each of the roller blade stop units 200 as shown in FIGS. 14 and 15. Thus, the conveyor unit 300 can be positioned between two roller, chain or belt conveyors.

In the conveyor unit 300 of FIGS. 13, 14 and 15, there is a position sensor 390 located substantially centrally within the conveyor component and between adjacent rollers 310. The position sensor is for detecting the position of a storage container between the first blade stop unit 100A and the second blade stop unit 100B. The position sensor sends a signal to a control system (not shown) and the control system controls movement of the drive mechanism 330, 340 in response to the signal from the position sensor 390. Whilst the position sensor 390 is not a necessary part of the conveyor component 300 because a storage container moving over the first blade stop unit 100A is stopped by the second blade stop unit 100B, the position sensor 390 aids in the movement of the storage container as part of a larger conveying system, as later explained.

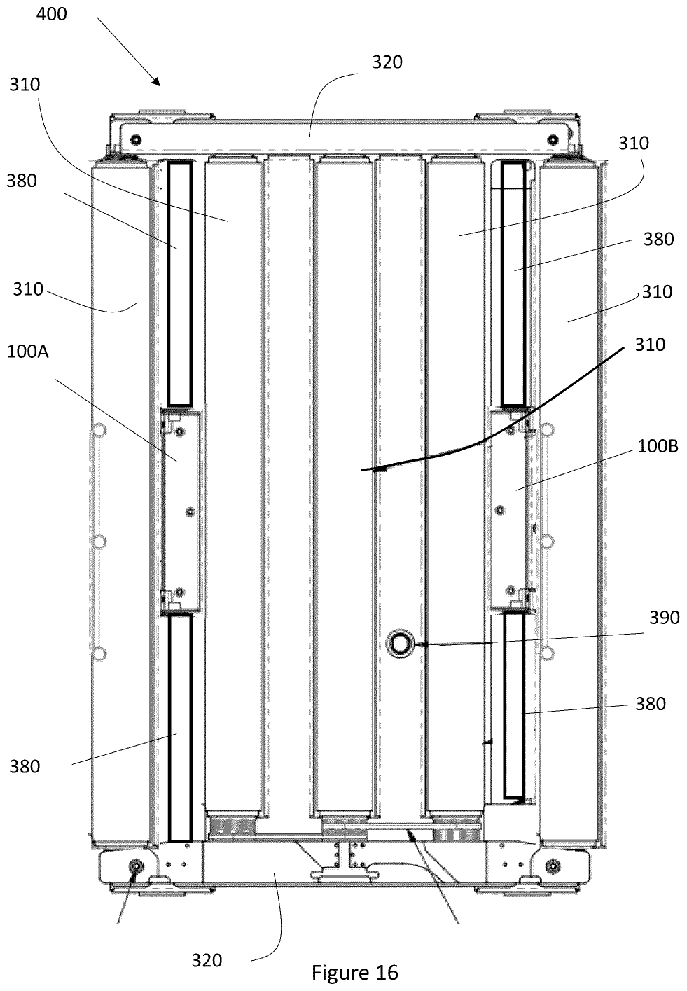

Instead of incorporating roller blade stop units 200 into a conveyor unit, it is also possible to attach blade stop units 100A, 100B to the frame 320 of the conveyor unit by a pair of beams or fixed rods 380 such that each blade stop unit 100A, 100B is positioned centrally along the width of the conveyor. This embodiment of a conveyor unit 400 is shown in FIG. 16. As shown in FIG. 16, the blade stop units 100A, 100B are positioned between adjacent rollers 310 and the distance between the stopping surfaces of the first blade stop unit 100A and the second blade stop unit 100B is equal to the depth of the storage container.

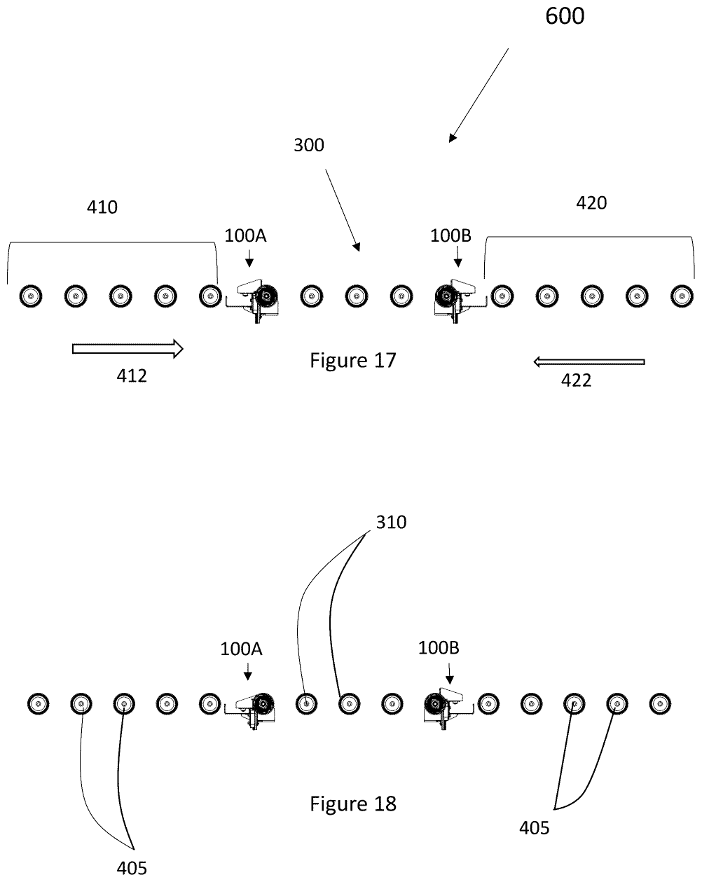

The conveyor units 300, 400 shown in FIG. 13-15 and 16 can be positioned between two roller conveyors. FIGS. 17 and 18 show a conveying system 600 in which the conveyor unit 300 of FIGS. 13, 14 and 15 is between a first conveyor 410 and a second conveyor 420. The first conveyor 410 moves a storage container along a first path 412 towards the conveyor unit 300. The second conveyor 420 moves a storage container along a second path 422 towards the conveyor unit 300.

The spacing between the series of rollers 310 in the conveyor unit 300 is the same as between the spacing between the rollers 405 of the first conveyor 410 and the second conveyor 420. However, it is also possible to have different spacing between the rollers 405 of the first and third conveyors 410, 420 and the series of rollers 310 in the conveyor unit 300. For example, the conveyor unit 300 may have half the spacing between the rollers and double the number of rollers compared to the spacing and the number of rollers in the first and second conveyors 410, 420. However, the distance between the first blade stop unit 100A and the second blade stop unit 100B remains equal to or substantially equal to (i.e., slightly larger than) the depth d of a storage container. The first conveyor 410 uses a drive belt to rotate its rollers in a clockwise direction such that a storage container moves along the first path 412, whilst the second conveyor 420 uses a drive belt to rotate its rollers in an anticlockwise direction such that a storage container moves along a second path 422. The second path 422 is directionally opposite the first path 412.

FIG. 17 shows an arrangement in which the ramp 102 of the first blade stop 100A and the ramp 102 of the second blade stop 100B are both in the raised position. In the raised position, the ramp 102 protrudes from the surface of the conveyors. The ramp may protrude by a few centimetres over the top surface of the conveyor 410, for example, 2 cm, 3 cm, 4 cm or 5 cm over the conveyor. FIG. 18 shows an arrangement in which the ramp 102 of the first blade stop 100A is in the retracted position, whilst the ramp 102 of the second blade stop 100B is in the raised position. In the retracted position, the highest point of the ramp 102 lies substantially level with the top surface of the rollers 405 of the conveyors, i.e., the ramp 102 of the first blade stop unit 100A retracts within the conveyor 410. This ensures that a storage container can move smoothly over the ramp 102 of the first blade stop 100A.

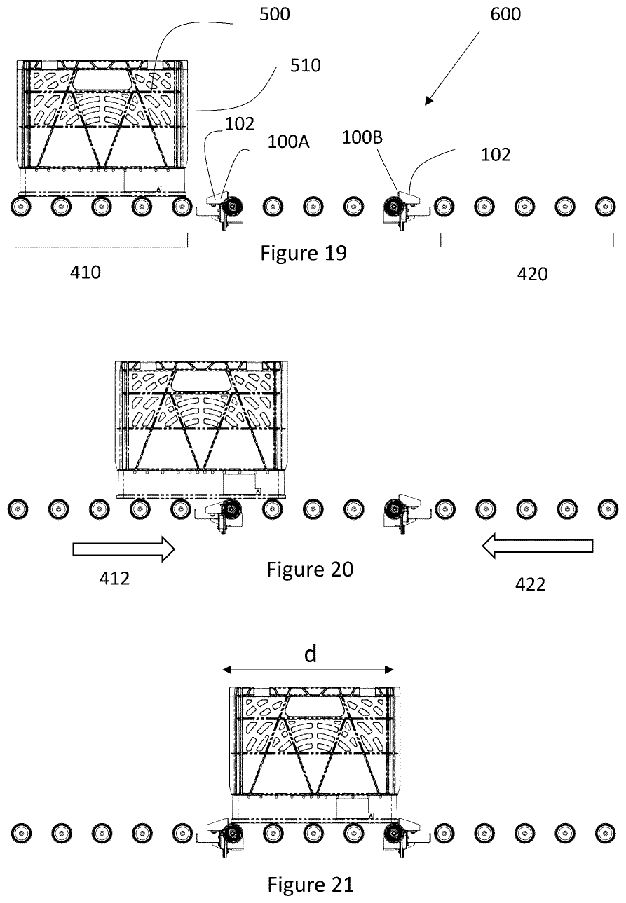

An example of how a storage container can move along the conveying system 600 is shown in FIGS. 19 to 21. The first conveyor 410 moves a container 500 (also termed a ‘storage container’) in a first path 412 towards the blade stop units 100A, 100B, i.e., the belt drive of the first conveyor 410 rotates clockwise. The container 500 rides over the ramp 102 of the first blade stop unit 100A, compressing the resilient member of the first blade stop unit 100A and forcing the ramp 102 and stopping surface of the first blade stop unit 100A into the retracted position, as shown in FIG. 20. In this position, the uppermost part of the ramp 102 of the first blade stop 100A is substantially level with the surface of the rollers, as shown more clearly in FIG. 18. Once the storage container has passed over the first blade stop unit 100A, the ramp 102 and stopping surface 105 of the first blade stop unit 100A returns to a raised position, as shown in FIG. 21, due to the spring being resiliently biased in the raised position. The second blade stop unit 100B is also in the raised position and the stopping surface of the second blade stop unit is orientated such that it stops the storage container 500 from moving further along its path. As shown in FIG. 21, the storage container is retained between the stopping surface 105 of the first blade stop unit 100A and the stopping surface 105 of second blade stop unit 100B because the stopping surfaces of each blade stop unit prevents the storage container from moving towards either conveyor. The storage container touches both the stopping surface 105 of the first blade stop unit 100A and the stopping surface 105 of the second blade stop unit 100B when in the position shown in FIG. 21.

Although not shown, it is also possible for a storage container to travel from the second conveyor 420 towards the second blade stop unit 100B, i.e., the drive belt of the second conveyor 420 rotates anticlockwise thereby conveying the storage container along the second path 422. In this situation, the container can ride over the ramp 102 of the second blade stop unit 100B, compressing the resilient member of the second blade stop unit 100B and forcing the ramp 102 and stopping surface 105 of the second blade stop unit 100B into the retracted position. Once the storage container has passed over the second blade stop unit 100B, the ramp 102 and stopping surface 105 of the second blade stop unit 100B returns to a raised position due to the spring being resiliently biased in the raised position. The ramp 102 and stopping surface 105 of the first blade stop unit 100A is also in the raised position and the stopping surface 105 of the first blade stop unit 100A is orientated such that it stops the storage container 500 from moving further along the second path. Thus, the storage container 500 is retained between the stopping surfaces 105 of the second blade stop unit 100B and the first blade stop unit 100A, as shown in FIG. 21, because the stopping surfaces of each blade stop unit prevents the storage container from moving towards either conveyor.

FIGS. 19, 20 and 21 show a conveying system 600 in which storage containers move in opposing directions. It is also possible for a blade stop unit to be incorporated into a conveying system in which the storage container 500 changes direction. In this instance, the conveying unit 300 of FIGS. 13, 14 and 15 additionally comprises a directional change mechanism, otherwise known as a belt transfer unit, for moving the storage container from one path into another path at right angles to the first path. A directional change conveyor unit comprises one or more rollers or belts or chains laterally disposed between or which interdigitate between the rollers 310 of the conveyor unit and are arranged to be driven transversely to the transport direction of the storage container on the first conveyor 410. The directional change conveyor unit is lowered or raised by a lifting mechanism (not shown) relative to the rollers of the first conveyor such that in a raised position, the directional change conveyor unit is in contact with a storage container causing the directional change conveyor unit to drag or pull the storage container from the rollers 310 between the first blade stop 100A and the second blade stop 100B onto a conveyor arranged perpendicular to the first conveyor 410. The directional change conveyor unit may be controllable such that it may be switched on to move the storage bin onto the perpendicular conveyor, or it may be switched off to halt the movement of the storage container so that the storage container does not move from between the first blade stop 100A and the second blade stop 100B. The directional change conveyor unit may be switched off, for example, if there is a fault with the storage container, and/or the storage container is to be extracted from the conveying system by for instance a robotic arm etc. Since the space between the stopping surfaces of the first blade stop 100A and the second blade stop 100B is sized to accommodate a single storage container, the stopping surfaces 105 provide guides for a storage container to move from the conveyor unit in a perpendicular path from its original path.

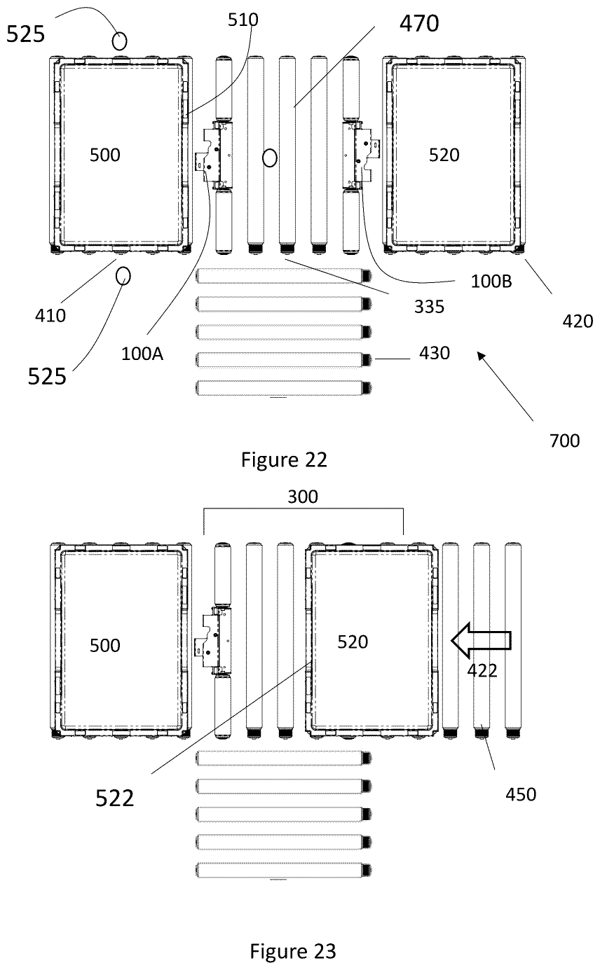

An example of a conveying system 700 which incorporates a conveying component 300 comprising a directional change conveyor unit thereby allowing a storage container to change paths is shown in FIGS. 22 to 28. Specifically, FIGS. 22 to 28 show step-by-step movement of a first storage container 500, a second storage container 520 and a third storage container 540 around the conveying system 700.

FIGS. 22 to 28 show three conveyors comprising rollers: a first conveyor 410, a second conveyor 420, and a third conveyor 450 arranged perpendicular to the first conveyor 410. The first conveyor 410 moves a storage container in a first path or first direction 412. The second conveyor 420 moves a storage container in a second path or third direction 422 which is directly opposite to the first path 412. The third conveyor 450 moves a storage container in a third path or direction 462 which is perpendicular to the first direction 412. The first blade stop unit 100A and the second blade stop unit 100B are located between the first conveyor 410 and the second conveyor 420. Specifically, the first blade stop unit 100A and the second blade stop unit 100B are located in the conveying component 300 as shown in FIGS. 13 to 15. Between the first conveyor 410 and the second conveyor 420 is a junction 470. The first blade stop unit 100A and the second blade stop unit 100B control the movement of a storage container into the junction 470. Specifically, the first blade stop unit 100A and the second blade stop unit 100B are located on either side of the junction. The third conveyor 450 comprises an entrance 335 in cooperation with the junction 470, and thus in cooperation with the first conveyor 410 and the second conveyor 420. The first blade stop unit 100A and the second blade stop unit 100B therefore control movement of a storage container 500 moving from the first conveyor 410 or the second conveyor 420 to the third conveyor 450.

The junction 470 between the first conveyor 410 and the second conveyor 420 comprises a directional change mechanism, otherwise known as a belt transfer unit, for moving the storage container from the first conveyor or the third conveyor to the second conveyor. A directional change conveyor unit comprises one or more rollers or belts or chains laterally disposed between or which interdigitate between the rollers of the conveyor unit and are arranged to be driven transversely to the transport direction of the conveyor unit. The directional change conveyor unit is lowered or raised by a lifting mechanism (not shown) relative to the rollers of the conveyor unit such that in the raised position, the directional change conveyor unit is in contact with a storage container causing the directional change conveyor unit to drag or pull the storage container from the conveyor unit 300 onto the third conveyor 450. The directional change conveyor unit may be controllable such that it may be switched on to move the storage container onto the third conveyor 450, or it may be switched off to halt the movement of the storage container so that the storage container does not move onto the third conveyor 450. The directional change conveyor unit may be switched off, for example, if there is a fault with the storage container, and/or the storage container is to be extracted from the conveying system by for instance a robotic arm etc.

In FIG. 22, there are two storage containers: a first container 500 and a second container 520. The first container 500 is positioned on the first conveyor 410 and has stopped before the first blade stop unit 100A. The first container 500 stops before the first blade stop unit 100A because the first conveyor 410 has stopped rotating its rollers. Specifically, the first conveyor 410 comprises a pair of sensors 525 located on either side of the conveyor 410 which sense the presence of the front side or wide edge 510 of the storage container 500 as it moves along the first conveyor 410. When the pair of sensors 525 sense the front side 510 of the first storage container 500, they send a signal to the control system (not shown) which then instructs the drive mechanism of the first conveyor 410 to stop the first conveyor. Thus, the first container 500 stops before it reaches the first blade stop unit 100A.

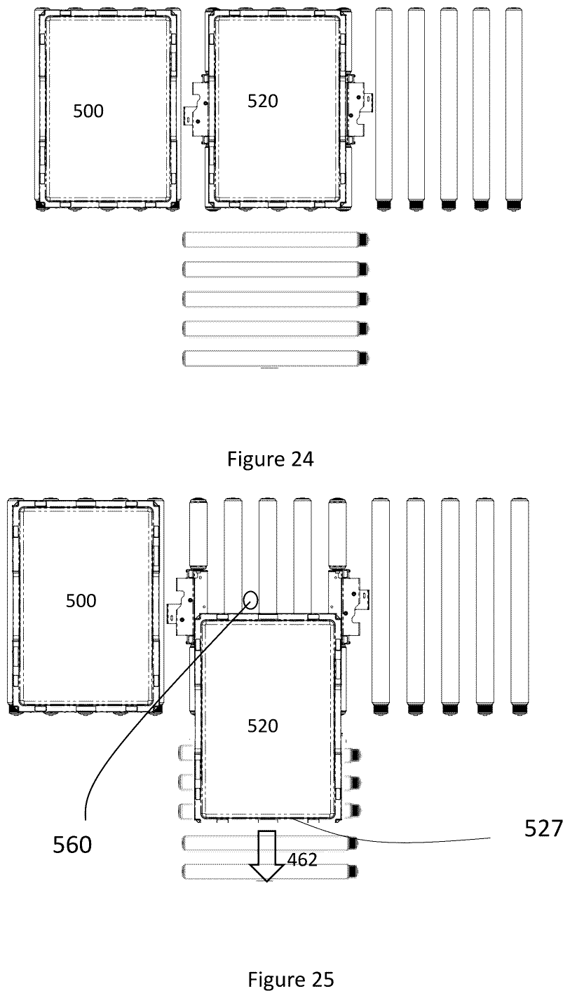

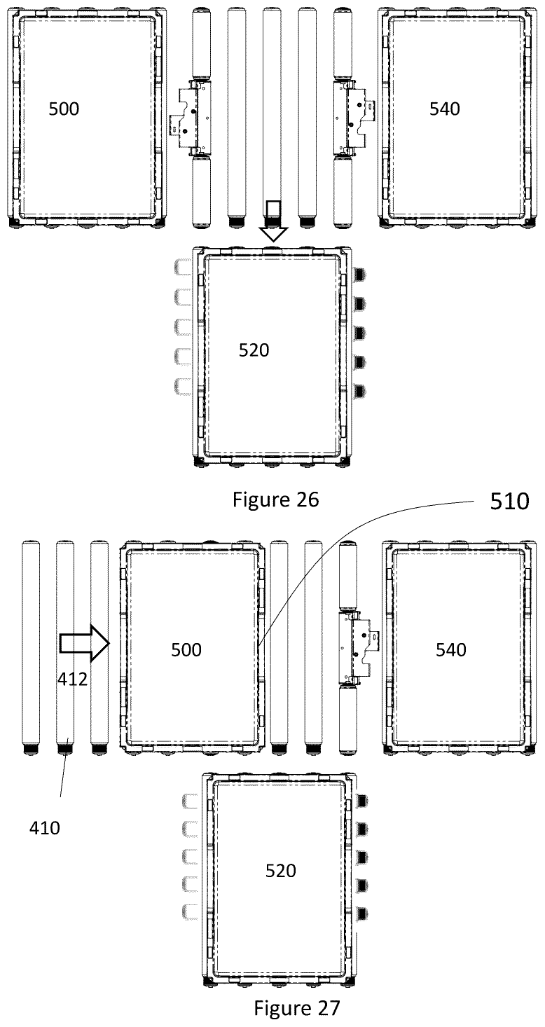

The control system then instructs the second conveyor 420 to rotate its rollers anticlockwise to convey a second container 520 in a second direction or path 422 which is a direction opposite to the movement of the first conveyor 410. The wide edge 522 is the leading edge of the second storage container 520 as it moves along the second path 422. The movement of the second conveyor 420 provides enough speed and momentum for the second container 520 to ride over the ramp 102 of the second blade stop unit 100B, thereby compressing the ramp of the second blade stop 100B such that it is in a retracted position. When the second container 520 has travelled over the second blade stop unit 100B, it enters the junction 470, as shown in FIG. 23. The second container 520 however is stopped from travelling beyond the junction (as shown in FIG. 24) by the first blade stop unit 100A which is arranged such that the stopping surface 105 faces the junction 470, thus the second container 520 butts up against the stopping surface 105 of the first blade stop unit 100A as the stopping surface 105 and the ramp 102 of the first blade stop unit 100A is biased in the raised position. Using the directional change mechanism located at the junction 470, the second storage container 520 can then be moved from the junction 470 to the third conveyor 450 such that the second storage container moves along a third path 462 which is perpendicular to the second path 422 of the second container 520, as shown in FIG. 25. The conveyor unit 300 which forms the junction 470 comprises a position sensor 560 which is positioned between adjacent rollers 310 of the conveyor unit 300. The position sensor 560 detects the presence of the second storage container 520 between the stopping surfaces 105 of the first blade stop unit 100A and the second blade stop unit 110B. When the second storage container is positioned between the stopping surfaces 105 of the first blade stop unit 100A and the second blade stop unit 100B, as shown in FIG. 24, the position sensor 560 sends a signal to the control unit which then instructs the directional change mechanism to operate and either pull or push the second storage container 520 from the conveyor unit 300 in a third path 462 onto the third conveyor 450, as shown in FIGS. 25 and 26. The second storage container 520 is pulled or pushed using the stopping surfaces 105 of first blade stop unit 100A and the second blade stop unit 100B as guides. Specifically, the second storage container does not change its orientation in the conveying system. Instead, the narrow edge 527 of the storage container is the leading edge of the second storage container 520 when it is transported and guided from the junction 470 to the third conveyor 450.

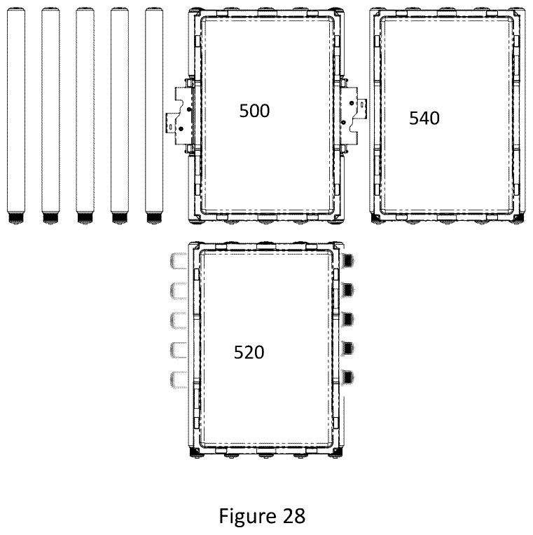

Once the second storage container 520 has moved from the junction 470, the first conveyor 410 is then instructed by the control system to rotate its rollers and thereby convey the first container 500 in a first direction 412 towards the junction 470, as shown in FIG. 27. Specifically, the wide edge 510 of the first container 500 is the leading edge of the container as it moves along the first path 412, as shown in FIG. 27. The first container 500 rides over the ramp 102 of the first blade stop unit 100A as the rollers of the first conveyor 410 provide enough velocity and therefore momentum to move the first container 500 up the ramp 102 of the first blade stop unit 100A, compressing the ramp downwards such that the ramp 102 of the first blade stop 100A is in the retracted position, allowing the first storage container 500 to travel over the first blade stop unit 100A into the junction 470. The first storage container 500 is stopped from travelling beyond the junction 470 by the stopping surface 105 of the second blade stop unit 100B which is in the raised position. The stopping surface 105 of the second blade stop unit 100B faces the junction 470. Therefore, the first storage container 500 butts up against the stopping surface 105 of the second blade stop unit 100B, as shown in FIG. 28. The first storage container 500 can then move from the junction to the third conveyor 450 by the directional change unit located at the junction, in the same way as shown for the movement of the second storage container 520 shown in FIG. 25.

The junction 470 of FIGS. 22 to 28 is described as a separate entity to the first conveyor 410 and the second conveyor 420. The junction is, as illustrated on FIGS. 22 to 28 a conveyor unit 300 of the type shown in FIGS. 13 to 16. However, the junction 470 may form part of the first conveyor 410, such that the first blade stop unit 100A and the second blade stop unit 100B are located between the rollers of the first conveyor 410 and the stopping surface 105 of the second blade stop unit 100B stops the movement of a storage container from the first conveyor 410 to the second conveyor 420. Similarly, the junction 470 may form part of the second conveyor 420, such that the first blade stop unit 100A and the second blade stop unit 100B are located between the rollers of the second conveyor 420 and the stopping surface 105 of the first blade stop unit 100A stops the movement of a storage container from the second conveyor 420 to the first conveyor 410.

The stopping surfaces 105 of the first blade stop unit 100A and the second blade stop unit 100B are important for the alignment of a storage container when moving from either the first conveyor 410 to the third conveyor 450 or from the second conveyor 420 to the third conveyor 450. Because the stopping surfaces of the first blade stop unit 100A and the second blade stop unit 100B are arranged such that they face each other and because the distance between the stopping surfaces 105 is equal to the depth d of the storage container, when the storage container is pushed or pulled from the junction or the space between the blade stop units 100A, 100B, the stopping surfaces act as guiding surfaces on either side of the storage container to ensure that the storage container is aligned with the entrance 335 of the third conveyor 450. This means that the storage container can travel along the third conveyor 450 in a third path 462 without crashing into the sidewalls of the third conveyor thereby minimising the likelihood of a built up of storage containers along the third conveyor.

It is also possible to have a four way junction comprising a first conveyor 410, a second conveyor 420, a third conveyor 450 and a fourth conveyor. The fourth conveyor may convey a storage container in a fourth path, the fourth path being directionally opposite the third path. This arrangement is possible if the directional change mechanism in the conveyor unit 300 at the junction can push or pull the storage container so that the storage container moves along the third path along the second conveyor or along the fourth path along the fourth conveyor depending on the direction of push or pull of the directional change mechanism. The stopping surface 105 of the first blade stop unit 100A and the stopping surface of the second blade stop unit 100B act as guiding surfaces to guide the storage container from the conveyor unit 300 to either the third path or the fourth path.

Whilst the preferred embodiments of the present invention have been described in detail above, it should be understood that various modifications of the blade stop unit and conveying system encompassing different features described above, and different combinations of features described in relation to different embodiments, are applications within the scope of the present invention as defined in the claims. It should be understood that various changes, substitutions and alterations can be made without departing from the scope of the invention as defined by the claims.

1. A conveying system, the conveying system comprising:
a conveyor arranged for conveying a storage container;
a body shaped to comprise a ramp to enable the storage container to move along a first path and a substantially vertical face forming a stopping surface for stopping the storage container from moving along a second path;
wherein the body is moveable between a retracted position to permit movement of the storage container along the first path of the conveyor and a raised position to prevent movement of the storage container along the second path of the conveyor; the second path being directionally opposite to the first path;
wherein the body is resiliently biased in the raised position and the bias is overcome by the storage container riding over the ramp.

2. A conveying system according to claim 1, wherein the body is formed as a single piece.

3. A conveying system according to claim 1, wherein the body further comprises a plate, said plate having a first face defining the stopping surface and a second face defining a mounting face, said ramp being mounted to the mounting face.

4. A conveying system according to claim 1, wherein the conveyor comprises at least one roller, and wherein a portion of the least one roller comprises the body.

5. A conveying system according to claim 1, wherein the body is positioned centrally along the width of the conveyor.

6. A conveying system according to claim 1, wherein the body is positioned between a pair of rollers.

7. A conveying system according to claim 4, wherein the body is moveably attached to a roller bracket to define a blade stop unit, said roller bracket being configured to support one or more rollers.

8. A conveying system according to claim 7, wherein the blade stop unit further comprises a carriage, the body being mounted to the carriage, said carriage being moveably attached to the roller bracket.

9. A conveying system according to claim 7, wherein the at least one blade stop unit comprises one or more springs for resiliently biasing the body in the raised position.

10. A conveying system according to claim 9, wherein the one or more springs are spring plungers.

11. A conveying system according to claim 9, wherein the one or more springs are rated to compress under the weight of a storage container having a weight equal to or greater than 4 kg.

12. A conveying system according to claim 7, wherein the ramp comprises an angle of inclination of between 15° and 20°.

13. A conveying system according to claim 7, wherein the blade stop unit comprises a blade stop comprising the stopping surface, wherein the blade stop and the ramp are formed as separate parts.

14. A conveying system according to claim 7, wherein the blade stop unit further comprises an actuator for locking the body into the raised position or the retracted position.

15. A conveying system according to claim 7, said at least one blade stop unit being defined as a first blade stop unit, the conveying system further comprising a second blade stop unit, the second blade stop unit comprising a second body comprising a ramp and a stopping surface, wherein the second blade stop unit is arranged such that the stopping surface of the second blade stop unit faces the stopping surface of the first blade stop unit.

16. A conveying system according to claim 15, wherein said conveyor is defined as a first conveyor, wherein the conveying system further comprises a second conveyor arranged for moving one or more storage containers along a third path substantially perpendicular to the first path of the first conveyor, wherein the second conveyor cooperates with the first conveyor at a junction where the third path intersects the first path to define an entrance of the second conveyor from the first conveyor, the first and second blade stop units being spaced apart to guide one or more storage containers along the third path through the entrance of the second conveyor.

17. A conveying system according to claim 16, wherein the conveying system further comprises a third conveyor for conveying a storage container along the second path parallel and opposite to the first path.

18. A conveying system according to claim 15, wherein the conveying system further comprises a conveying unit, the conveying unit comprising the first blade stop unit, the second blade stop unit and a series of rollers, the first blade stop unit and the second blade stop unit being spaced apart by a series of rollers such that a storage container is guided by the stopping surfaces of the first blade stop unit and the second blade stop unit.

19. A conveying system of claim 1, further comprising:
i) a drive mechanism for driving movement of the conveyor;
ii) a control system for controlling the drive mechanism;
iii) at least one position sensor for detecting the position of the storage container along the conveyor;
wherein the control system is configured to control movement of the conveyor in response to one or more signals from the at least one sensor.
